(19) United States
(12) Patent Application Publication
(10) Pub. No.: US 2025/0221581 A1
(43) Pub. Date: Jul. 10, 2025

(54) Hand And Foot Bathing Device

(71) Applicant: Sayed Tauqeer Ahmed, Aliso Viejo, CA (US)

(72) Inventor: Sayed Tauqeer Ahmed, Aliso Viejo, CA (US)

(21) Appl. No.: 18/408,977

(22) Filed: Jan. 10, 2024

(51) Int. Cl. A47K 3/12; A47K 3/022; A61H 35/00

(52) U.S. Cl. CPC A47K 3/122; A47K 3/022; A61H 35/006; A61H 2205/065; A61H 2205/12

(57) ABSTRACT

A hand and foot bathing device for facilitating a user to perform Wudu in accordance to the Muslim faith includes a bathtub that has a perimeter wall which has a height that is no greater than 15.0 cm to facilitate a user to easily step into the bathtub to perform Wudu in accordance with the Muslim faith. The perimeter wall has an entry which has a height that is less than the height of the perimeter wall to facilitate the user to enter the bathtub without having to step over the perimeter wall. A bench is mounted to the perimeter wall of the bathtub to facilitate the user to sit on the bench. In this way the user can wash their hands and feet and face in a seated position while the user performs Wudu. Furthermore, the bench has an adjustable height to accommodate the height of the user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to bathing devices and more particularly pertains to a new bathing device for facilitate a user to perform Wudu in accordance with the Muslim faith. The device includes a bathtub which has a perimeter wall that has a height which is no greater than 15.0 cm and an entry in the perimeter wall that has height which is less than the height of the perimeter wall. The device includes a bench, which as an adjustable height, that is attached to the perimeter wall of the bathtub. The user can sit on the bench thereby facilitating the user to perform Wudu in accordance with the Muslim faith while in a seated position thereby inhibiting the user from falling and potentially being injured.

### (2) Description of Related Art including information disclosed under 37 CFR 1.97 and 1.98.

The prior art relates to bathing devices including a variety of handicapped accessible bathtub devices that each at least includes a seat which is integrated into a bathtub and in at least one instance includes an entry that integrated into the bathtub. In no instance does the prior art disclose a bathtub device that has a perimeter wall which has a height that is no greater than 15.0 cm and an entry integrated into the perimeter wall and bench that is attached to the perimeter wall to facilitate a user to be seated while performing Wudu in accordance with the Muslim faith.

### BRIEF SUMMARY OF THE INVENTION

An embodiment of the disclosure meets the needs presented above by generally comprising a bathtub that has a perimeter wall which has a height of less than 15.0 cm to facilitate a user to easily step into the bathtub to perform Wudu in accordance with the Muslim faith. The perimeter wall has an entry which has a height that is less than the height of the perimeter wall to facilitate the user to enter the bathtub without having to step over the perimeter wall. A bench is mounted to the perimeter wall of the bathtub to facilitate the user to sit on the bench. In this way the user can wash their hands and feet and face in a seated position while the user performs Wudu. Furthermore, the bench has an adjustable height to accommodate the height of the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a hand and foot bathing device according to an embodiment of the disclosure.

FIG. 2 is a left side phantom view of an embodiment of the disclosure.

FIG. 3 is a top view of an embodiment of the disclosure.

FIG. 4 is a front view of an embodiment of the disclosure.

FIG. 5 is a perspective in-use view of an embodiment of the disclosure.

FIG. 6 is a cross sectional view taken along line 6-6 of FIG. 4 of an embodiment of the disclosure.

FIG. 7 is a magnified view of a leg of an embodiment of the disclosure.

### DETAILED DESCRIPTION OF THE INVENTION

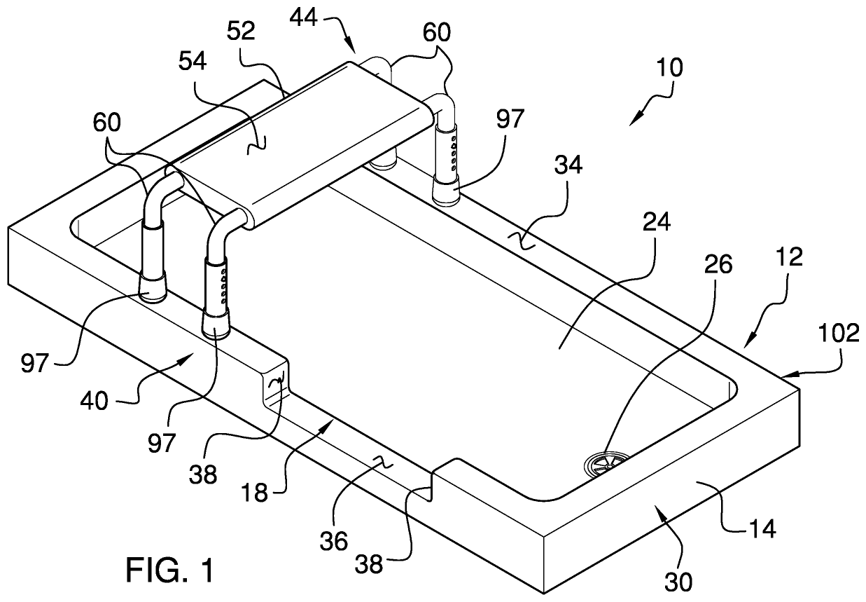

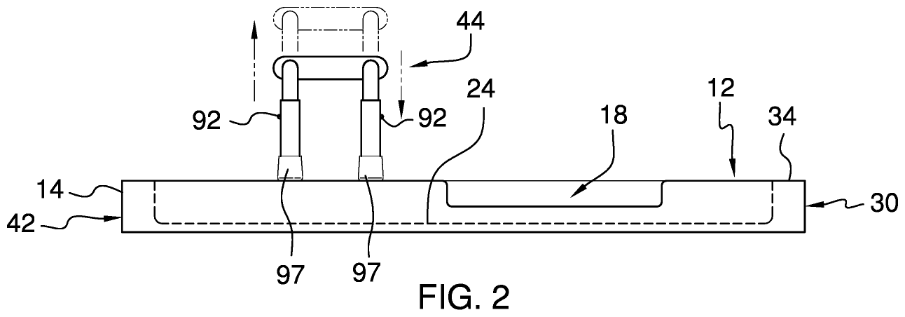

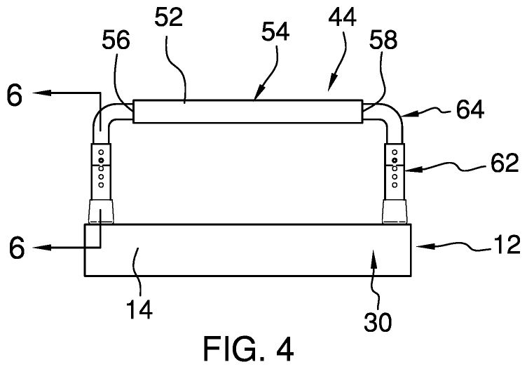

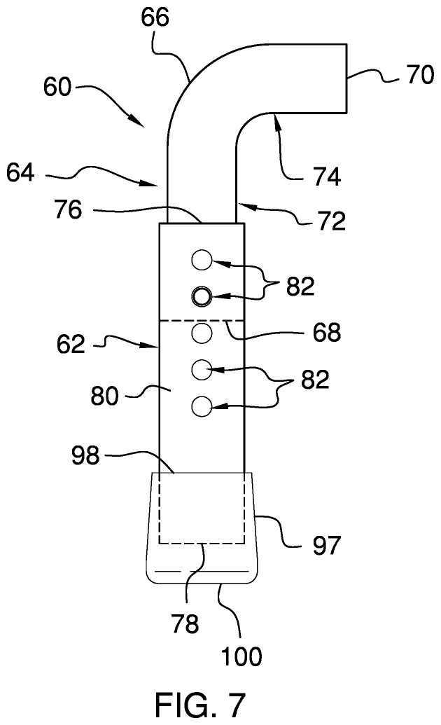

With reference now to the drawings, and in particular to FIGS. 1 through 7 thereof, a new bathing device embodying the principles and concepts of an embodiment of the disclosure and generally designated by the reference numeral 10 will be described.

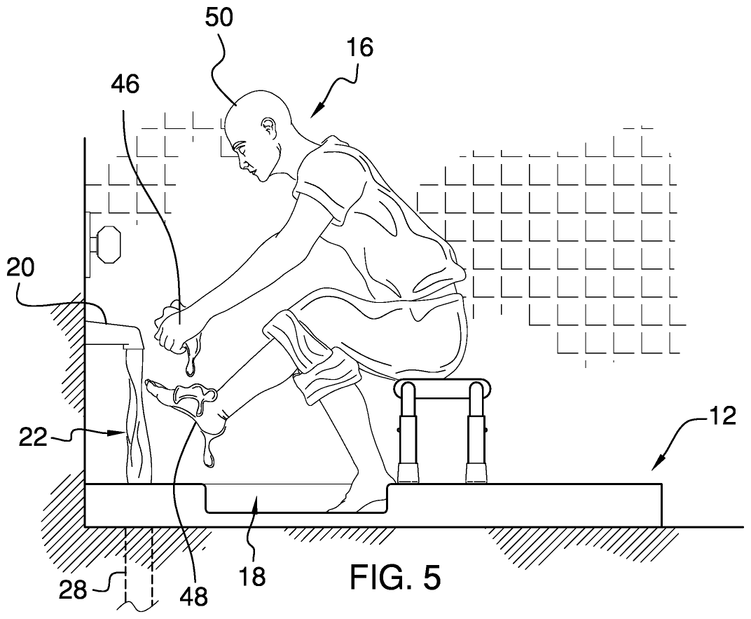

As best illustrated in FIGS. 1 through 7, the hand and foot bathing device 10 generally comprises a bathtub 12 that has a perimeter wall 14 which has a height no greater than 15.0 cm to facilitate a user 16 to easily step into the bathtub 12 to perform Wudu in accordance with the Muslim faith. Additionally, the perimeter wall 14 has an entry 18 which has a height that is less than the height of the perimeter wall 14 to facilitate the user 16 to enter the bathtub 12 without having to step over the perimeter wall 14. As is most clearly shown in FIG. 5, the bathtub 12 may be located in a bathroom such that a faucet of a shower 20, for example, which is positioned over the bathtub 12 to supply water 22 for the user 16 to perform Wudu.

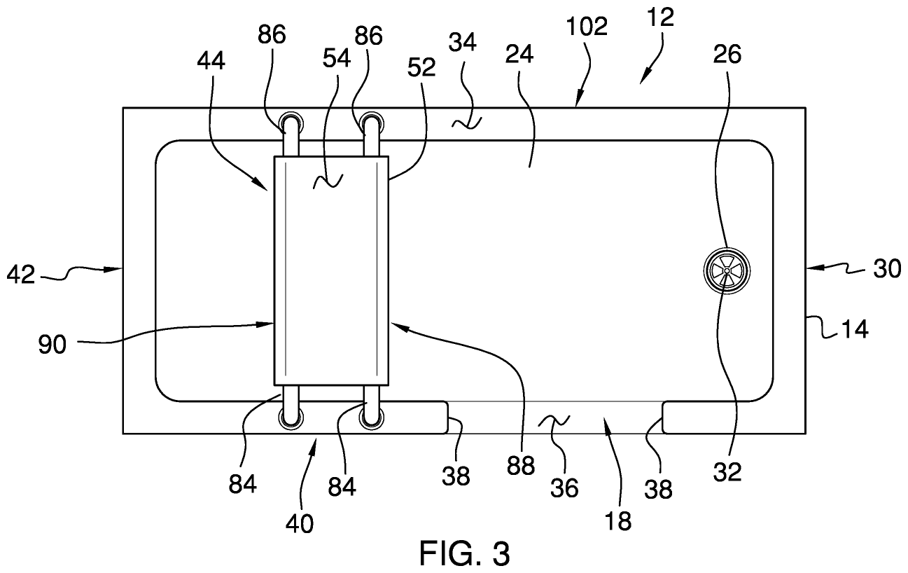

The perimeter wall 14 extends upwardly from a basal wall 24 of the bathtub 12 and the bathtub 12 has a drain 26 extending through the basal wall 24 to drain the water 22 from the bathtub 12. The drain 26 may be plumbed to a sewer pipe 28 of the bathroom such that the water 22 in the bathtub 12 can drain into the sewer pipe 28. Additionally, the drain 26 is positioned adjacent to a front side 30 of the perimeter wall 14 and, as is most clearly shown in FIG. 3, the drain 26 may include a foraminous debris screen 32 to inhibit hair and debris from passing through the drain 26. The perimeter wall 14 has a top surface 34 and the entry 18 has an upper surface 36 that is spaced downwardly from the top surface 34 of the perimeter wall 14. Additionally, the entry 18 has a pair of lateral bounding surfaces 38 each extending between the upper surface 36 of the entry 18 and the top surface 34 of the perimeter wall 14. The entry 18 is positioned on a first lateral side 40 of the perimeter wall 14 and the entry 18 is positioned closer to the front side 30 of the perimeter wall 14 than a back side 42 of the perimeter wall 14.

A bench 44 is mounted to the perimeter wall 14 of the bathtub 12 to facilitate the user 16 to sit on the bench 44 thereby facilitating the user 16 to wash their hands 46 and feet 48 and face 50 in a seated position while the user 16 performs Wudu. The bench 44 has an adjustable height to accommodate the height and preference of the user 16 and the bench 44 comprises a seat 52 which has a top surface 54, a first lateral surface 56 and a second lateral surface 58. The user 16 can sit on the top surface 54 and the seat 52 is elongated between the first lateral surface 56 and the second lateral surface 58. The seat 52 is comprised of a fluid impermeable material, including but not being limited to plastic or polyvinylchloride, thereby facilitating the seat 52 to resist becoming wet from water 22 while the user 16 is performing Wudu. Additionally, the seat 52 may include a cushion, comprised of a resiliently compressible material, that is positioned within the seat 52 to enhance comfort for the user 16. The bench 44 is positioned between the entry 18 and the back side 42 of the perimeter wall 14 of the bathtub 12.

The bench 44 includes a plurality of legs 60 and each of the legs 60 has a lower section 62 which slidably receives an upper section 64 such that each of the plurality of legs 60 has a telescopically adjustable height. The upper section 64 of each of the plurality of legs 60 has a bend 66 which is centrally located between a first end 68 and a second end 70 of the upper section 64 of a respective leg 60. Furthermore, the bend 66 in each of the legs 60 defines a first portion 72 forming an angle with a second portion 74 of the plurality of legs 60. The first end 68 is associated with the first portion 72 and the second end 70 is associated with the second portion 74.

The lower section 62 of each of the plurality of legs 60 has a top end 76 that is open which insertably receives the first end 68 of the upper section 64 of a respective leg 60 such that the second portion 74 of upper section 64 of the respective leg 60 is directed laterally away from the lower section 62 of the respective leg 60. Additionally, the lower section 62 of each of the plurality of legs 60 has a bottom end 78 that is closed and an outer wall 80 extending between the top end 76 and the bottom end 78. The outer wall 80 of the lower section 62 of each of the plurality of legs 60 has a plurality of holes 82 which are evenly spaced apart from each other and are distributed between the top end 76 and the bottom end 78.

The plurality of legs 60 includes a pair of first legs 84 and a pair of second legs 86. The second end 70 of the upper section 64 of each of the pair of first legs 84 is attached to the first lateral surface 56 of the seat 52. Additionally, the upper section 64 of each of the pair of first legs 84 is spaced from a respective one of a front surface 88 and a back surface 90 of the seat 52. The second end 70 of the upper section 64 of each of the pair of second legs 86 is attached to the second lateral surface 58 of the seat 52. Furthermore, the upper section 64 of each of the pair of second legs 86 is spaced from a respective one of the front surface 88 and the back surface 90 of the seat 52.

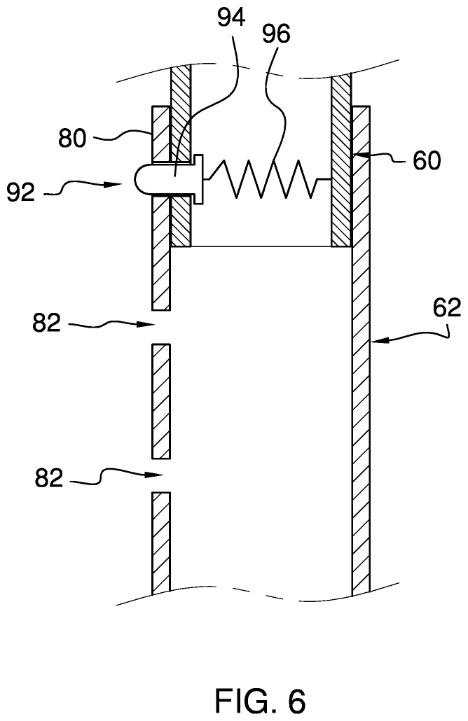

The bench 44 includes a plurality of locks 92 and each of the plurality of locks 92 is movably integrated into the first portion 72 of the upper section 64 of a respective one of the plurality of legs 60. Each of the plurality of locks 92 is biased to extend outwardly through a respective one of the plurality of holes 82 in the outer wall 80 of the lower section 62 of a respective one of the legs 60 thereby retaining the legs 60 at a desired height. Each of the plurality of locks 92 is urgeable inwardly toward the first portion 72 of the upper section 64 of the respective leg 60 such that the locks 92 are displaced from the respective hole 82. In this way the first portion 72 of the upper section 64 of the respective leg 60 can be slid upwardly or downwardly in the lower section 62 of the respective leg 60 for adjusting a height of the respective leg 60. As is most clearly shown in FIG. 6, each of the plurality of locks 92 may comprise a knob 94 and a biasing member 96 that is positioned within the first portion 72 of the upper section 64 of the respective leg 60 which biases the knob 94 outwardly from the first portion 72 of the upper section 64 of the respective leg 60.

A plurality of feet 97 is provided and each of the plurality of feet 97 has a topmost end 98 that is open and a bottommost end 100 that is closed. The topmost end 98 of each of the plurality of feet 97 insertably receives the bottom end 78 of the lower section 62 of a respective one of the plurality of legs 60. Additionally, the bottommost end 100 of each of the plurality of feet 97 which are attached to a respective one of the pair of first legs 84 is attached to the top surface 54 corresponding to the first lateral side 40 the perimeter wall 14 of the bathtub 12. Furthermore, the bottommost end 100 of each of the plurality of feet 97 which are attached to a respective one of the pair of second legs 86 is attached to the top surface 54 corresponding to a second lateral side 102 of the perimeter wall 14 of the bathtub 12. In this way the seat 52 is oriented to extend substantially between the first lateral side 40 and the second lateral side 102 of the perimeter wall 14 of the bathtub 12.

In use, the user 16 steps through the entry 18 in the perimeter wall 14 of the bathtub 12 to enter the bathtub 12 and the user 16 sits upon the seat 52 of the bench 44. In this way the user 16 can be seated while the user 16 washes their feet 97 and hands 46 and face 50 in accordance with Wudu prior to praying in the manner required by the Muslim faith. Thus, the user 16 does not have to perform Wudu in a bathroom sink, for example, or in a conventional bathtub that would come with the risk of potentially falling and being injured. Additionally, the length of each of the plurality of legs 60 can be adjusted to suit the height of the user 16 or to accommodate the user's 16 preferences.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hand and foot bathing device for facilitating a practitioner of the Muslim faith to clean their hands and feet and face in a seated position while performing Wudu, said device comprising:
a bathtub having a perimeter wall which has a height that is no greater than 15.0 cm wherein said bathtub is configured to facilitate a user to easily step into said bathtub to perform Wudu in accordance with the Muslim faith, said perimeter wall having an entry which has a height being less than the height of said perimeter wall wherein said entry is configured to facilitate the user to enter said bathtub without having to step over said perimeter wall; and
a bench being mounted to said perimeter wall of said bathtub wherein said bench is configured to facilitate the user to sit on said bench thereby facilitating the user to wash their hands and feet and face in a seated position while the user performs Wudu, said bench having an adjustable height wherein said bench is configured to accommodate the height of the user.

2. The device according to claim 1, wherein:
said perimeter wall extends upwardly from a basal wall of said bathtub;
said bathtub has a drain extending through said basal wall wherein said drain is configured to drain water from said bathtub;
said drain is positioned adjacent to a front side of said perimeter wall;
said perimeter wall has a top surface;
said entry has an upper surface being spaced downwardly from said top surface of said perimeter wall;
said entry has a pair of lateral bounding surfaces each extending between said upper surface of said entry and said top surface of said perimeter wall;
said entry is positioned on a first lateral side of said perimeter wall; and
said entry is positioned closer to said front side of said perimeter wall than a back side of said perimeter wall.

3. The device according to claim 1, wherein:
said bench comprises:
a seat;
said seat has a top surface and a first lateral surface and a second lateral surface wherein said top surface is configured to facilitate the user to sit on said top surface;
said seat is elongated between said first lateral surface and said second lateral surface; and
said seat is comprised of a fluid impermeable material wherein said seat is configured to resist becoming wet from water while the user is performing Wudu; and
a plurality of legs;
each of said legs has a lower section which slidably receives an upper section such that each of said plurality of legs has a telescopically adjustable height;
said upper section of each of said plurality of legs has a bend being centrally located between a first end and a second end of said upper section of a respective leg thereby defining a first portion forming an angle with a second portion of said upper section of said plurality of legs;
said first end is associated with said first portion;
said second end is associated with said second portion;
said lower section of each of said plurality of legs has a top end being open which insertably receives said first end of said upper section of a respective leg such that said second portion of said upper section of said respective leg is directed laterally away from said lower section of said respective leg;
said lower section of each of said plurality of legs has a bottom end being closed and an outer wall extending between said top end and said bottom end; and
said outer wall of said lower section of each of said plurality of legs has a plurality of holes being evenly spaced apart from each other and being distributed between said top end and said bottom end.

4. The device according to claim 3, wherein:
said plurality of legs includes a pair of first legs and a pair of second legs;
said second end of said upper section of each of said pair of first legs is attached to said first lateral surface of said seat;
said upper section of each of said pair of first legs is spaced from a respective one of a front surface and a back surface of said seat;
said second end of said upper section of each of said pair of second legs is attached to said second lateral surface of said seat; and
said upper section of each of said pair of second legs is spaced from a respective one of said front surface and said back surface of said seat.

5. The device according to claim 3, wherein:
said device includes a plurality of locks;
each of said plurality of locks is movably integrated into said first portion of said upper section of a respective one of said plurality of legs;
each of said plurality of locks is biased to extend outwardly through a respective one of said plurality of holes in said outer wall of said lower section of a respective one of said legs thereby retaining said legs at a desired height; and
each of said plurality of locks is urgeable inwardly toward said first portion of said upper section of said respective leg such that said locks are displaced from said respective hole thereby facilitating said first portion of said upper section of said respective leg to be slid upwardly or downwardly in said lower section of said respective leg for adjusting a height of said respective leg.

6. The device according to claim 4, wherein:
said bathtub has a perimeter wall, said perimeter wall having a top surface and a first lateral side and a second lateral side;
said device includes a plurality of feet;
each of said plurality of feet has a topmost end being open and a bottommost end being closed;
said topmost end of each of said plurality of feet insertably receives said bottom end of said lower section of a respective one of said plurality of legs;
said bottommost end of each of said plurality of feet which are attached to a respective one of said pair of first legs is attached to said top surface corresponding to said first lateral side said perimeter wall of said bathtub; and
said bottommost end of each of said plurality of feet which are attached to a respective one of said pair of second legs is attached to said top surface corresponding to said second lateral side of said perimeter wall of said bathtub such that said seat is oriented to extend substantially between said first lateral side and said second lateral side of said perimeter wall of said bathtub.

7. A hand and foot bathing device for facilitating a practitioner of the Muslim faith to clean their hands and feet and face in a seated position while performing Wudu, said device comprising:
a bathtub having a perimeter wall which has a height that is no greater than 15.0 cm wherein said bathtub is configured to facilitate a user to easily step into said bathtub to perform Wudu in accordance with the Muslim faith, said perimeter wall having an entry which has a height being less than the height of said perimeter wall wherein said entry is configured to facilitate the user to enter said bathtub without having to step over said perimeter wall, said perimeter wall extending upwardly from a basal wall of said bathtub, said bathtub having a drain extending through said basal wall wherein said drain is configured to drain water from said bathtub, said drain being positioned adjacent to a front side of said perimeter wall, said perimeter wall having a top surface, said entry having an upper surface being spaced downwardly from said top surface of said perimeter wall, said entry having a pair of lateral bounding surfaces each extending between said upper surface of said entry and said top surface of said perimeter wall, said entry being positioned on a first lateral side of said perimeter wall, said entry being positioned closer to said front side of said perimeter wall than a back side of said perimeter wall; and
a bench being mounted to said perimeter wall of said bathtub wherein said bench is configured to facilitate the user to sit on said bench thereby facilitating the user to wash their hands and feet and face in a seated position while the user performs Wudu, said bench having an adjustable height wherein said bench is configured to accommodate the height of the user, said bench comprising:
a seat having a top surface and a first lateral surface and a second lateral surface wherein said top surface is configured to facilitate the user to sit on said top surface, said seat being elongated between said first lateral surface and said second lateral surface, said seat being comprised of a fluid impermeable material wherein said seat is configured to resist becoming wet from water while the user is performing Wudu;
a plurality of legs, each of said legs having a lower section which slidably receives an upper section such that each of said plurality of legs has a telescopically adjustable height, said upper section of each of said plurality of legs having a bend being centrally located between a first end and a second end of said upper section of a respective leg thereby defining a first portion forming an angle with a second portion of said upper section of said plurality of legs, said first end being associated with said first portion, said second end being associated with said second portion, said lower section of each of said plurality of legs having a top end being open which insertably receives said first end of said upper section of a respective leg such that said second portion of said respective leg is directed laterally away from said lower section of said respective leg, said lower section of each of said plurality of legs having a bottom end being closed and an outer wall extending between said top end and said bottom end, said outer wall of said lower section of each of said plurality of legs having a plurality of holes being evenly spaced apart from each other and being distributed between said top end and said bottom end, said plurality of legs including a pair of first legs and a pair of second legs, said second end of said upper section of each of said pair of first legs being attached to said first lateral surface of said seat, said upper section of each of said pair of first legs being spaced from a respective one of a front surface and a back surface of said seat, said second end of said upper section of each of said pair of second legs being attached to said second lateral surface of said seat, said upper section of each of said pair of second legs being spaced from a respective one of said front surface and said back surface of said seat;
a plurality of locks, each of said plurality of locks being movably integrated into said first portion of said upper section of a respective one of said plurality of legs, each of said plurality of locks being biased to extend outwardly through a respective one of said plurality of holes in said outer wall of said lower section of a respective one of said legs thereby retaining said legs at a desired height, each of said plurality of locks being urgeable inwardly toward said first portion of said upper section of said respective leg such that said locks are displaced from said respective hole thereby facilitating said first portion of said upper section of said respective leg to be slid upwardly or downwardly in said lower section of said respective leg for adjusting a height of said respective leg; and
a plurality of feet, each of said plurality of feet having a topmost end being open and a bottommost end being closed, said topmost end of each of said plurality of feet insertably receiving said bottom end of said lower section of a respective one of said plurality of legs, said bottommost end of each of said plurality of feet which are attached to a respective one of said pair of first legs being attached to said top surface corresponding to said first lateral side said perimeter wall of said bathtub, said bottommost end of each of said plurality of feet which are attached to a respective one of said pair of second legs being attached to said top surface corresponding to a second lateral side of said perimeter wall of said bathtub such that said seat is oriented to extend substantially between said first lateral side and said second lateral side of said perimeter wall of said bathtub.
